(19) United States
(12) Patent Application Publication
(10) Pub. No.: US 2023/0294198 A1
(43) Pub. Date: Sep. 21, 2023

(54) SPOT WELDING MONITORING METHOD AND SPOT WELDING MONITORING SYSTEM

(71) Applicant: SUBARU CORPORATION, Tokyo (JP)

(72) Inventor: Tatsunori MATSUNAGA, Tokyo (JP)

(73) Assignee: SUBARU CORPORATION, Tokyo (JP)

(21) Appl. No.: 18/114,471

(22) Filed: Feb. 27, 2023

(30) Foreign Application Priority Data
Mar. 15, 2022 (JP) 2022-039949

(51) Int. Cl. B23K 11/25; B23K 11/11; B23K 31/12

(52) U.S. Cl. CPC B23K 11/257; B23K 11/115; B23K 31/125

(57) ABSTRACT

A spot welding monitoring method is configured to monitor a state of spot welding that holds a work including metal plates stacked on each other, between electrodes in a pair, and supplies electricity between electrodes. The spot welding monitoring method includes: by a converter disposed in a vicinity of a weld zone of the work, detecting a change in magnetic flux density of a magnetic field generated around the weld zone by the supplying of the electricity between electrodes, and converting the change in the magnetic flux density into a current; and calculating three-dimensional data on a melting zone of the work, based on a temporal change in a value of the current.

### CROSS-REFERENCE TO RELATED APPLICATION

The present application claims priority from Japanese Patent Application No. 2022-039949 filed on Mar. 15, 2022, the entire contents of which are hereby incorporated by reference.

### BACKGROUND

The disclosure relates to a spot welding monitoring method and a spot welding monitoring system that monitor a state of a weld zone during supply of electricity in spot welding.

Known spot welding is an existing technique that holds a work including multiple metal plates stacked on each other between a pair of electrodes at a welding point position, and supplies current from one electrode to the other electrode, to thereby join the stacked metal plates.

The spot welding uses electric resistance of the metal plates at the place held between the pair of electrodes and generates heat by supply of electricity to melt the metal plates, and thereafter stops the supply of electricity to thereby cool a melting zone and join the metal plates to each other.

Quality of the spot welding is mainly determined on the basis of whether a nugget with an appropriate diameter is formed between the metal plates. Inspection of the quality of the spot welding may be performed during welding or after welding. In terms of increasing welding quality, inspection during welding, i.e., monitoring of a welding state, is to be performed.

As a technique of performing quality inspection during welding, Japanese Patent No. 4595760 discloses a spot welding monitoring method that predicts a nugget diameter to be formed between metal plates on the basis of a welding current and a welding voltage.

In this monitoring method, first, a resistance value of each steel plate is calculated, on the basis of welding parameters including the welding current and the welding voltage used in spot welding, and plate strengths and plate thicknesses of the steel plates to be welded. From this resistance value, a current path diameter and an average temperature of a current path are calculated for each steel plate. The calculated current path diameter and average temperature are used to calculate a current path diameter and an average temperature of a contact surface between the overlapped steel plates. The nugget diameter of a weld zone between the steel plates is predicted on the basis of a result of the calculation.

### SUMMARY

An aspect of the disclosure provides a spot welding monitoring method configured to monitor a state of spot welding that holds a work including metal plates stacked on each other, between electrodes in a pair, and supplies electricity between the electrodes. The spot welding monitoring method includes: by a converter disposed in a vicinity of a weld zone of the work, detecting a change in magnetic flux density of a magnetic field generated around the weld zone by the supplying of the electricity between electrodes, and converting the change in the magnetic flux density into a current; and calculating three-dimensional data on a melting zone of the work, based on a temporal change in a value of the current.

An aspect of the disclosure provides a spot welding monitoring system configured to monitor a state of spot welding that holds a work including metal plates stacked on each other, between electrodes in a pair, and supplies electricity between the electrodes. The spot welding monitoring system includes a converter and a calculation device. The converter is configured to be disposed in a vicinity of a weld zone of the work, and to detect a change in magnetic flux density of a magnetic field generated around the weld zone by the supplying of the electricity between the electrodes, and convert the change in the magnetic flux density into a current. The calculation device is configured to calculate three-dimensional data on a melting zone of the work, based on a temporal change in a value of the current acquired by the converter.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic explanatory diagram illustrating a spot welding monitoring system according to one example embodiment of the disclosure.

FIG. 2 is a plan view of an example of a configuration around tips of electrodes in welding.

FIG. 3 is a side view of the example of the configuration around the tips of the electrodes in welding.

FIG. 4A is a perspective view of a detection part of a converter.

FIG. 4B is an exploded perspective view of the detection part of the converter.

FIG. 5 is a flowchart illustrating a monitoring method.

FIG. 6 is a graph illustrating a temporal change in magnetic flux density of each part in a radial direction of a weld zone.

FIG. 7 is a graph illustrating a temporal change in current obtained on the basis of the temporal change in the magnetic flux density.

FIG. 8 is a graph illustrating a temporal change in joint diameter obtained on the basis of the graph in FIG. 7.

FIG. 9 is a diagram illustrating the joint diameter of the weld zone and a thickness of an IMC measured by using the monitoring system.

### DETAILED DESCRIPTION

In a monitoring method disclosed in Japanese Patent No. 4595760, it is possible to predict a nugget diameter of a weld zone after the end of supply of electricity, by calculating a current path diameter of a contact surface between steel plates, i.e., a diameter of a melting zone between the steel plates, during welding.

However, it has been difficult by an existing monitoring method to recognize a state of a melting zone as three-dimensional data during welding.

It is desirable to provide a spot welding monitoring method and a spot welding monitoring system that make it possible to recognize a state of a melting zone as three-dimensional data during welding in spot welding.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

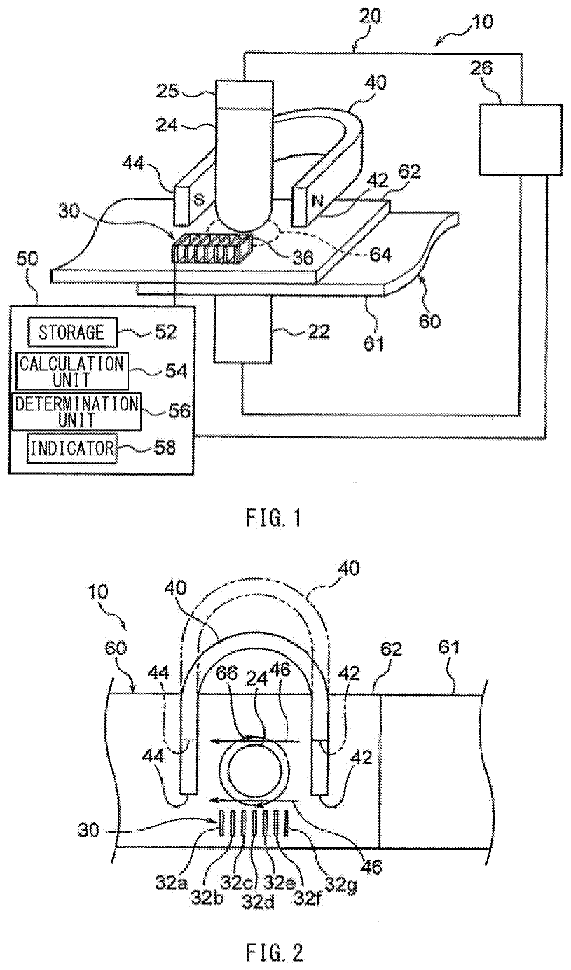

FIG. 1 is a perspective view illustrating an outline of a spot welding monitoring system (hereinafter also referred to as a monitoring system) 10 according to an example embodiment of the disclosure. The monitoring system 10 is configured to monitor a state of so-called spot welding, or resistance spot welding. The spot welding holds a work 60 including multiple metal plates stacked on each other, between a pair of electrodes, and supplies electricity. The multiple metal plates may be, for example, a first metal plate 61 and a second metal plate 62. The pair of electrodes may be, for example, a fixed electrode 22 and a movable electrode 24.

The monitoring system 10 may include a spot welding device 20, a converter 30, a magnetic field generator 40, and a calculation device 50. The spot welding device 20 may perform the spot welding on the work 60. The converter 30 converts a change in magnetic flux into a current. The calculation device 50 may include a storage 52 that stores information, a calculation unit 54, a determination unit 56, and an indicator 58. The spot welding device 20, the converter 30, and the calculation device 50 may be electrically coupled to each other.

The spot welding device 20 may bring the pair of electrodes (the fixed electrode 22 and the movable electrode 24) into contact with the work 60 including the multiple metal plates (the first metal plate 61 and the second metal plate 62) at least partly overlapped. The spot welding device 20 may supply electricity between the fixed electrode 22 and the movable electrode 24, while holding the work 60 between the pair of electrodes (the fixed electrode 22 and the movable electrode 24) by applying a predetermined pressure. The spot welding device 20 may thereby join the first metal plate 61 and the second metal plate 62. The example embodiment describes an example of joining the first metal plate 61 including a steel plate and the second metal plate 62 including an aluminum alloy.

In a case where the first metal plate 61 and the second metal plate 62 are plate materials including different metal materials as in the example embodiment, an intermetallic compound (hereinafter, referred to as an IMC) such as Fe₂Al₃ or FeAl₃ may be generated at a joint interface resulting from the spot welding. In the monitoring system 10 according to the example embodiment, the calculation device 50 may calculate the thickness of the IMC as will be described later. Note that the first metal plate 61 and the second metal plate 62 joined to each other may include the same metal material, for example, may be steel plates or aluminum alloys. In such a case, calculation of the thickness of the IMC may be omitted.

The spot welding device 20 may include the fixed electrode 22, the movable electrode 24, and a welding control processor 26. The fixed electrode 22 may be fixed to an unillustrated device body of the spot welding device 20. The movable electrode 24 may be disposed to be opposed to the fixed electrode 22. The movable electrode 24 may be attached to a drive mechanism 25 including, for example, a hydraulic cylinder or a servomotor. The movable electrode 24 may be configured to be movable forward or backward in an axial direction of a central axis of the movable electrode 24 by operation of the drive mechanism 25. The welding control processor 26 may be electrically coupled to the drive mechanism 25, the fixed electrode 22, and the movable electrode 24. The welding control processor 26 may perform control of the forward or backward movement of the movable electrode 24, and control of a value of current to be applied between the fixed electrode 22 and the movable electrode 24. Configurations of the fixed electrode 22 and the movable electrode 24, for example, a round (R) shape of a tip of each electrode, may be set as appropriate. The spot welding device 20 may be used in, for example, a manufacturing process for vehicles such as automobiles (e.g., joining of plate materials included in vehicle bodies in a manufacturing line for mass production of the vehicle bodies).

The welding control processor 26 may include, for example, an information processing unit such as a central processing unit (CPU), a storage such as a random access memory (RAM) or a read only memory (ROM), and an input-output interface. The welding control processor 26 may perform control of the forward or backward movement of the movable electrode 24 and control of, for example, the pressure to be applied to the work 60 and the current value of a welding current to be supplied to the fixed electrode 22 and the movable electrode 24, on the basis of a program stored in the storage. The program may include, for example, a vertical position of the movable electrode 24 and the pressure to be applied at each timing, and a current to be supplied between the fixed electrode 22 and the movable electrode 24 at each timing.

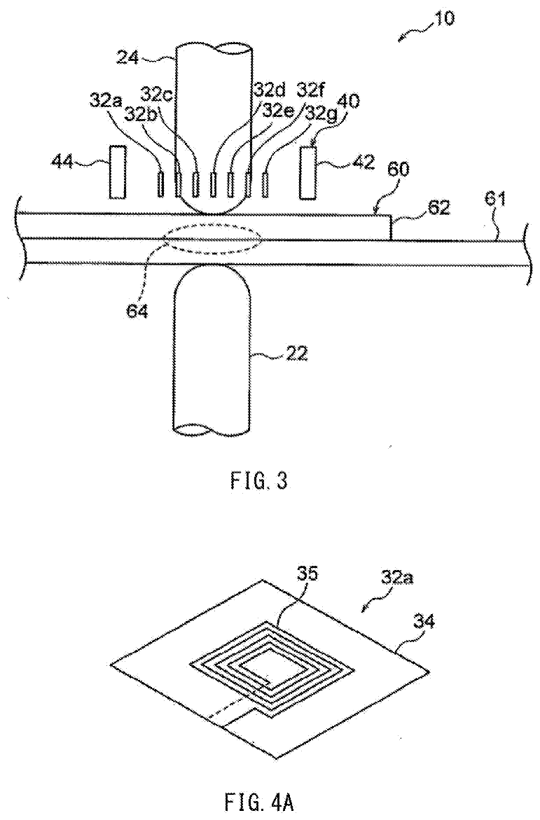

The converter 30 is configured to convert a change in magnetic flux into a current. The converter 30 may include multiple detection parts 32a, 32b, 32c, 32d, 32e, 32f, and 32g. As illustrated in FIG. 1 to FIG. 3, the detection parts 32a to 32g may each have a thin sheet shape, and may be arranged in layers at intervals. As illustrated in FIG. 1, in the example embodiment, the detection parts 32a to 32g may be arranged in layers by being held in a frame-shaped holding case 36. Note that, in FIG. 2 and FIG. 3, illustration of the holding case 36 is omitted for easier understanding of positions where the detection parts 32a to 32g are disposed. Note that the number of the detection parts 32a to 32g is not limited to seven, and at least three or more detection parts may be provided to be able to detect the middle and both ends in a radial direction of a weld zone 64.

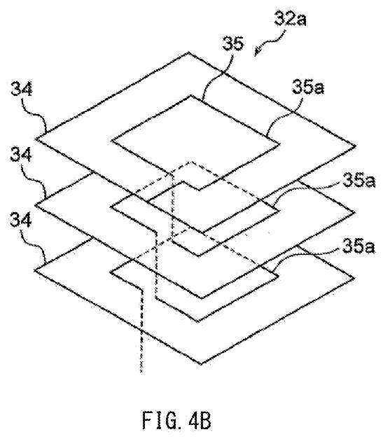

The detection parts 32a to 32g may each include a sheet-shaped coil. FIG. 4A is a perspective view of the detection part 32a, and FIG. 4B is an exploded perspective view of the detection part 32a. The detection part 32a may include an electric conductor 35 having a substantially ring-shaped pattern 35a open at both ends and disposed in each layer of a sheet-shaped wiring board 34 with a multilayer stricture. The ends of the patterns 35a of the layers may be sequentially coupled via a through hole to form the sheet-shaped coil. Note that the other detection parts 32b to 32g may be configured similarly to the detection part 32a. The electric conductor 35 may be coupled to the calculation device 50. The sheet-shaped coil serving as the detection part 32a may detect and convert a change in magnetic field density into a current, and the converted value of the current may be measured by the calculation device 50.

The converter 30 is disposed in the vicinity of the weld zone 64 of the work 60. The weld zone 64 of the work 60 may refer to a part where the first metal plate 61 and the second metal plate 62 are melted and joined by the spot welding in the work 60. As illustrated in FIG. 3, the detection parts 32a to 32g of the converter 30 may be disposed in the vicinity of the weld zone 64, not being in contact with the work 60, and may be arranged at predetermined intervals in the radial direction of the weld zone 64. In the converter 30, the detection part 32d positioned in the middle may be disposed to be at a central position in the radial direction of the weld zone 64. The detection parts 32a and 32g positioned at both ends in the radial direction of the weld zone 64 may be set on the basis of a preset size of a nugget of the spot welding, and may be disposed, for example, to be at substantially the same position as both ends in the radial direction of the nugget to be formed in the work 60.

As illustrated in FIG. 2, if electricity is supplied between the fixed electrode 22 and the movable electrode 24 in a state in which the work 60 is held between the pair of electrodes (the fixed electrode 22 and the movable electrode 24), a magnetic field 66 may be generated around a part of the work 60 that is supplied with the electricity and melted by heating. FIG. 2 illustrates the magnetic field 66 in a case where current is supplied from the movable electrode 24 to the fixed electrode 22 side. An intensity, i.e., a magnitude of magnetic flux density, of the magnetic field 66 may become larger as the weld zone 64, or the nugget, of the work 60 heated and melted by supply of electricity grows and an amount of electricity supplied to the weld zone 64 becomes larger. If the magnetic flux density of the magnetic field 66 thus changes, electromagnetic induction, i.e., self-induction, is caused to cancel out the change in the magnetic flux density. To cancel out the magnetic field 66 by the self-induction, counter electromotive force may be generated in the coils of the detection parts 32a to 32g. The converter 30 may detect a change in magnetic flux based on the self-induction, and convert the change in the magnetic flux into a current based on the counter electromotive force, by means of the detection parts 32a to 32g. This enables the converter 30 to convert, into a current for each part, the change in the magnetic flux in the parts in the radial direction of the weld zone 64 of the work 60 detected by the detection parts 32a to 32g.

The magnetic field generator 40 may be configured to generate a magnetic field that amplifies the magnetic field 66 generated in the vicinity of the weld zone 64 of the work 60. A magnet that generates a magnetic field may be used as the magnetic field generator 40. In the example embodiment, a U-shaped permanent magnet having a N pole side 42 and a S pole side 44 may be used. The magnetic field generator 40 is not limited thereto, and may be an electromagnet that is able to adjust a magnitude of magnetic force.

The magnetic field generator 40 and the converter 30 may be disposed in a positional relationship that allows the magnetic flux to be detected by the detection parts 32a to 32g of the converter 30 to be amplified by the magnetic field generator 40. In the example embodiment, for example, the magnetic field generator 40 may be disposed with the movable electrode 24 between the N pole side 42 and the S pole side 44 in such a manner that the weld zone 64 is positioned between the N pole side 42 and the S pole side 44 in plan view, as illustrated in FIG. 2. Note that the position where the magnetic field generator 40 is disposed is not limited thereto, and may be a position shifted from the movable electrode 24 in plan view, as indicated by a dashed and double-dotted line in FIG. 2. The converter 30 may be disposed, with respect to the magnetic field generator 40, at a position at which the intensity of the magnetic field 66 generated around the weld zone of the work 60 by the supply of electricity between the fixed electrode 22 and the movable electrode 24 is amplifiable by a magnetic field 46 generated by the magnetic field generator 40, i.e., a position at which the magnetic flux detected by the detection parts 32a to 32g is amplifiable.

The converter 30 and the magnetic field generator 40 may be coupled to the drive mechanism 25 of the spot welding device 20 to be movable together with the movable electrode 24, or may be configured to be movable separately from the movable electrode 24. Further, in the example illustrated in FIG. 1, the converter 30 and the magnetic field generator 40 may be disposed on the movable electrode 24 side with respect to the work 60. Alternatively, a configuration in which the converter 30 and the magnetic field generator 40 are disposed on the fixed electrode 22 side with respect to the work 60 may be used. In such a case, the converter 30 and the magnetic field generator 40 may be fixedly installed on the device body of the spot welding device 20.

The calculation device 50 may include, for example, an information processing unit such as a central processing unit (CPU) or an application specific integrated circuit (ASIC), a storage such as a RAM or a ROM, and an input-output interface. The calculation device 50 may calculate three-dimensional data on a melting zone of the work 60, on the basis of a temporal change in the value of the current of each part acquired by each of the detection parts 32a to 32g of the converter 30.

As already described above, the calculation device 50 may include the storage 52 that stores information, the calculation unit 54, the determination unit 56, and the indicator 58. The storage 52 may store data indicating a correlation between a temporal change in current value and a size of a joint diameter of the weld zone 64, preset on the basis of an experiment, for example. The size of the joint diameter may encompass, for example, a size of a diameter of the melting zone and a thickness of the melting zone during supply of electricity, a size of a nugget diameter and a thickness of the nugget after supply of electricity. In the example embodiment, the data indicating the correlation may further include data indicating a relationship between the temporal change in the current value and the thickness of the IMC generated at the joint interface.

The storage 52 may also store preset weld zone reference data that serves as a reference for quality determination of the weld zone 64. The weld zone reference data may include three-dimensional data to be used to determine an appropriate shape of the weld zone 64, or the nugget, in a cooled and joined state after supply of electricity. The weld zone reference data may further include three-dimensional data indicating an appropriate growth process of the melting zone during supply of electricity.

The calculation unit 54 may calculate three-dimensional data on the weld zone 64, on the basis of the value of the current of each part of the weld zone 64 acquired by the converter 30, i.e., the current value acquired by each of the detection parts 32a to 32g. The calculation unit 54 may calculate the three-dimensional data regarding the weld zone 64 (e.g., the three-dimensional data on the melting zone of the work 60 during supply of electricity) in real time, on the basis of current value data received from the converter 30.

The determination unit 56 may determine whether quality of the weld zone 64 is favorable or unfavorable, by comparing the three-dimensional data on the weld zone 64 calculated by the calculation unit 54, and the preset weld zone reference data stored in the storage 52.

The indicator 58 is configured to indicate information visually and/or auditorily, and may include, for example, a display and/or a speaker. A calculation result obtained by the calculation unit 54 and a determination result obtained by the determination unit 56 may be indicated by the indicator 58.

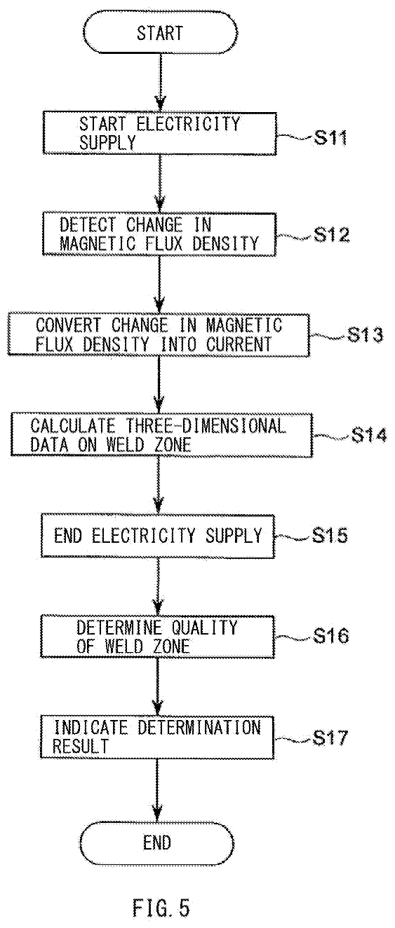

Described next is a spot welding monitoring method using the monitoring system 10 described above. FIG. 5 is a flowchart illustrating processing to be performed by the monitoring system 10.

The processing may be started in a state in which the converter 30 and the magnetic field generator 40 are set at predetermined positions, and the work 60 is set at a predetermined welding position. In step S11, the drive mechanism 25 of the spot welding device 20 may operate to bring the movable electrode 24 close to the fixed electrode 22, and supply of electricity between the fixed electrode 22 and the movable electrode 24 may be started in a state in which the work 60 is held and subjected to the applied pressure between the fixed electrode 22 and the movable electrode 24 (an electricity supply step).

Upon start of the supply of electricity, in step S12, each of the detection parts 32a to 32g of the converter 30 may detect a change in magnetic flux density caused by electricity being supplied to the weld zone 64, and in step S13, each of the detection parts 32a to 32g may convert the detected change in the magnetic flux density into a current (a conversion step).

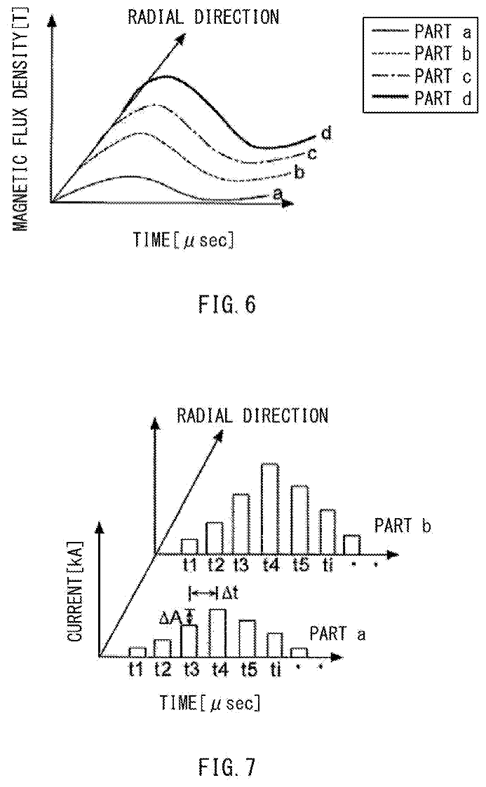

FIG. 6 is a graph illustrating an example of a temporal change in the magnetic flux density detected by the detection parts 32a, 32b, 32c, and 32d in step S12. In FIG. 6, the magnitude of the magnetic flux density may represent an absolute value. In the graph in FIG. 6, parts “a”, “b”, “c”, and “d” represent the detection parts 32a, 32b, 32c, and 32d respectively. Although not illustrated, the changes in the magnetic flux density of the detection parts 32e, 32f, and 32g corresponding to parts “e”, “f”, and “g” in the radial direction of the weld zone 64 may respectively have waveforms substantially similar to those of the detection parts 32c, 32b, and 32a, and illustration thereof is therefore omitted. As illustrated in FIG. 6, the change in the magnetic flux density may be largest in the part “d” disposed at the central position in the radial direction of the weld zone 64, and may become smaller toward an edge in the radial direction.

FIG. 7 illustrates the processing in step S13. FIG. 7 is a graph in which the temporal change in the magnetic flux density illustrated in FIG. 6 is converted into a temporal change in the current value. In FIG. 7, a time interval Δt between times t1, t2, t3, ... and ti may be set constant. FIG. 7 illustrates, as an example, the temporal change in the current value of the parts “a” and “b” in FIG. 6. Although not illustrated, data on the temporal change in the current value obtained by converting the change in the magnetic flux density into a current may be generated similarly for the parts “c” to “g”.

In subsequent step S14, the calculation device 50 may calculate the three-dimensional data on the melting zone of the work 60, on the basis of the temporal change in the current value in each of the parts “a” to “g” acquired in step S13 (a calculation step). The three-dimensional data may be calculated on the basis of the data indicating the correlation between the temporal change in the current value and the size of the joint diameter of the weld zone 64, stored in the storage 52 of the calculation device 50. In the example embodiment, the three-dimensional data that is calculated may include two pieces of three-dimensional data of first three-dimensional data and second three-dimensional data. The first three-dimensional data may be three-dimensional data indicating a three-dimensional shape of the melting zone at a given time. The second three-dimensional data may be three-dimensional data indicating changes in diameter and current value of the melting zone with elapse of time. The second three-dimensional data may be, for example, data having an x-axis, a y-axis, and a z-axis orthogonal to each other, in which the x-axis represents the time, the y-axis represents the current value, and the z-axis represents the joint diameter. In step S15, the supply of electricity by the spot welding device 20 may be ended. The monitoring in step S12 to step S14 may be performed at least until the end of the supply of electricity.

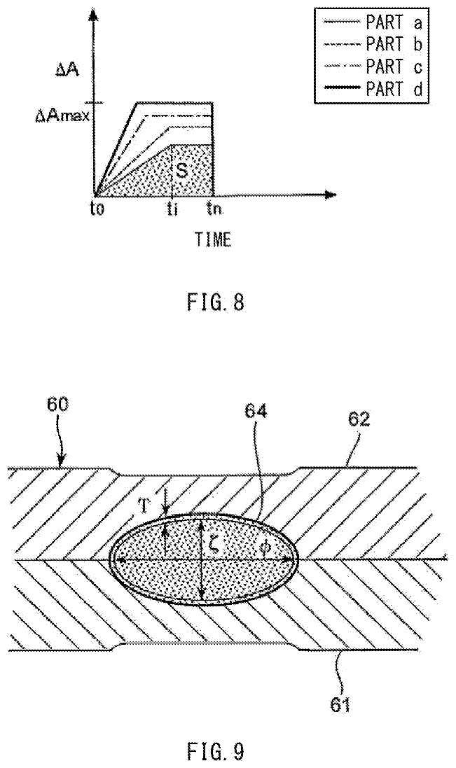

FIG. 8 is a graph illustrating a temporal change in the joint diameter of the weld zone 64 obtained on the basis of the current value calculated in step S14. In the graph in FIG. 8, the horizontal axis represents time, t₀ and tₙ respectively represent an electricity supply start time and an electricity supply end time in the spot welding. In addition, the vertical axis represents a difference ΔA in the current value before the current value becomes largest, or an absolute value of the difference ΔA, in the temporal change in the current value of each part illustrated in the graph in FIG. 7. Although illustration is omitted in FIG. 8, graphs of the parts “e”, “f”, and “g” may respectively be graphs substantially similar to those of the parts “c”, “b”, and “a”. In FIG. 8, tᵢ may be a calculated value, or a constant, based on an experiment. As illustrated in FIG. 8, in the part “d” positioned in the middle of the weld zone 64, the difference ΔA (or the absolute value of the difference ΔA), i.e., the amount of supplied electricity, is larger than in the other parts, and this value may have a correlation with a size of a joint diameterζ²φ of the weld zone 64 illustrated in FIG. 9. Note that φ may be a diameter of the weld zone 64, and may ζ be a thickness of the middle of the weld zone 64. A maximum value ΔAₘₐₓ in the part “d” in FIG. 8 may represent the joint diameter ζφ of the nugget in FIG.

9. In addition, an area S of the part “a” indicated by dots in the graph in FIG. 8 may represent heat input energy, and may have a correlation with a thickness T of the IMC of the weld zone 64 illustrated in FIG. 9.

For example, it may be estimated that the area S (heat input energy)≈(2tₙ−tₙ₋₁)/2) ΔA≈(tₙ²/2) ΔA. In addition, a volume V of the weld zone 64 may be obtained on the basis of the equation of an ellipse represented by Expression 1, and the volume of a solid of revolution about the x-axis, represented by Expression 2, regarding the ellipse.

$$\frac{{x}^{2}}{{a}^{2}} + \frac{{y}^{2}}{{b}^{2}} = 1 \qquad Expression 1$$

$$V = π {\int }_{a}^{b} {\{ f ( x ) \}}^{2} d x \qquad Expression 2$$

In Expression 1 and Expression 2, a≈φ and b≈ζ may be substituted, and V≈πζ²φ/6 may be obtained.

In addition, heat capacity C=ρVc (where C: heat capacity, ρ: density, V: volume, and c: specific heat). It may be estimated that the heat capacity C≈ the heat input energy (area S).

According to these expressions, C≈ρV≈πρζ²φ/6 and the joint diameter ζ²φ≈ζ²φ≈(3tₙ²/πρ)ΔA may be obtained.

As described above, the first three-dimensional data indicating the shape of the weld zone 64 may be calculated by the joint diameter being calculated at each time, and the second three-dimensional data may be calculated by the changes in the current value and the joint diameter with the elapse of time being calculated. Note that the calculation device 50 may be configured to calculate at least one piece of three-dimensional data. On the basis of such a relationship, the calculation device 50 is able to calculate the size of the joint diameter and the thickness of the IMC in real time, which makes it possible to three-dimensionally recognize, in real time, the shape of the weld zone 64 during supply of electricity and after supply of electricity.

In subsequent step S16, after the end of the supply of electricity, it may be determined whether the quality of the weld zone 64 is favorable or unfavorable, on the basis of the three-dimensional data on the weld zone 64 calculated by the calculation device 50 (a determination step). The quality may be determined by comparing the three-dimensional data on the weld zone 64 after completion of welding, i.e., the three-dimensional data regarding the shape of the nugget of the work 60 after welding, acquired by the calculation device 50, with the preset weld zone reference data in the storage 52. In a case where the three-dimensional data on the weld zone 64 serving as a monitoring result falls within an allowable range of the weld zone reference data, it may be determined that the quality is favorable. In a case where the three-dimensional data on the weld zone 64 falls outside the allowable range, it may be determined that the quality is unfavorable.

In subsequent step S17, the determination result may be indicated by the indicator 58 of the calculation device 50. This may be the end of the monitoring and quality inspection for the spot welding on one work 60. In a case of applying the monitoring system 10 to a manufacturing line for mass production of vehicle bodies, the quality inspection using the monitoring method described above may be performed each time welding is performed on one work 60.

As described above, in the spot welding monitoring method using the monitoring system 10 according to the example embodiment, the change in the magnetic flux density caused by a change in amount of current flowing through the weld zone 64 may be converted into a current by each of the detection parts 32a to 32g of the converter 30. Reading the resulting current value makes it possible to detect the amount of current flowing through the weld zone 64, i.e., the amount of current used for a melting phenomenon, in real time. Thus, a state of the weld zone 64 may be monitored in real time, by using a current waveform of the counter electromotive force generated by the change in the magnetic flux density, which makes it possible to acquire the three-dimensional data on the weld zone 64, and perform inspection of the state of the weld zone 64 in a non-destructive manner. In addition, in a case where the first metal plate 61 and the second metal plate 62 are plate materials including different metal materials as in the example embodiment, it is possible to calculate the thickness of the IMC generated at the joint, on the basis of data on the detected current value.

In the example embodiment, the magnetic flux generated in the vicinity of the weld zone 64 may be amplified by using the magnetic field generator 40, to make the change in the magnetic flux density detected by each of the detection parts 32a to 32g larger. This makes it possible to improve detection accuracy. In the spot welding, the value of the current that flows between the fixed electrode 22 and the movable electrode 24 may be large. It is therefore possible to detect, by the converter 30, the change in the magnetic flux density of the parts “a” to “g” in the radial direction of the weld zone 64, even without using the magnetic field generator 40. However, increasing a width of the change by the magnetic field generator 40 makes it possible to improve the accuracy.

In the example embodiment, whether the quality of the weld zone 64 is favorable or unfavorable may be determined by using the three-dimensional data. This results in a large amount of information as compared with a case of performing quality inspection simply on the basis of only the nugget diameter, making it possible to perform the quality inspection with high accuracy.

Further, in the example embodiment, when performing the spot welding on the work 60 in a mass production process, it is possible to perform the quality inspection at the same time. This makes it unnecessary to additionally provide a step for inspection after welding, making it possible to shorten takt time.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

According to an example embodiment of the disclosure, a spot welding monitoring method is configured to monitor a state of spot welding that holds a work including metal plates stacked on each other, between a pair of electrodes, and supplies electricity between the pair of electrodes. The spot welding monitoring method includes: by a converter disposed in a vicinity of a weld zone of the work, detecting a change in magnetic flux density of a magnetic field generated around the weld zone by the supplying of the electricity between the pair of electrodes, and converting the change in the magnetic flux density into a current; and calculating three-dimensional data on a melting zone of the work, on the basis of a temporal change in a value of the current.

According to an example embodiment of the disclosure, in the spot welding monitoring method, the detecting and converting of the change in the magnetic flux density may include amplifying the magnetic flux density of the magnetic field generated around the weld zone, by a magnetic field generator disposed in a vicinity of the weld zone.

According to an example embodiment of the disclosure, in the spot welding monitoring method, the detecting and converting of the change in the magnetic flux density may include, by the converter, detecting a change in magnetic flux density in each of parts in a radial direction of the weld zone, and converting the change in the magnetic flux density detected in each of the parts into a current.

According to an example embodiment of the disclosure, the spot welding monitoring method may further include determining whether quality of the weld zone is favorable or unfavorable, by comparing the calculated three-dimensional data and preset weld zone reference data.

According to an example embodiment of the disclosure, a spot welding monitoring system is configured to monitor a state of spot welding that holds a work including metal plates stacked on each other, between a pair of electrodes, and supplies electricity between the pair of electrodes. The spot welding monitoring system includes a converter and a calculation device. The converter is configured to be disposed in a vicinity of a weld zone of the work, and to detect a change in magnetic flux density of a magnetic field generated around the weld zone by the supplying of the electricity between the pair of electrodes, and convert the change in the magnetic flux density into a current. The calculation device is configured to calculate three-dimensional data on a melting zone of the work, on the basis of a temporal change in a value of the current acquired by the converter.

According to an example embodiment of the disclosure, the spot welding monitoring system may further include a magnetic field generator configured to be disposed in a vicinity of the weld zone, and to amplify magnetic flux generated around the weld zone.

According to an example embodiment of the disclosure, in the spot welding monitoring system, the converter may include detection parts configured to detect a change in magnetic flux density in each of parts in a radial direction of the weld zone, and the converter may be configured to convert the change in the magnetic flux density detected by each of the detection parts into a current.

According to an example embodiment of the disclosure, in the spot welding monitoring system, the calculation device may be configured to determine whether quality of the weld zone is favorable or unfavorable, by comparing the calculated three-dimensional data and preset weld zone reference data.

A spot welding monitoring method and a spot welding monitoring system according to at least one embodiment of the disclosure make it possible to recognize a state of a melting zone as three-dimensional data during welding in spot welding.

The calculation device 50 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the calculation device 50. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and an SRAM, and the nonvolatile memory may include a ROM and an NVRAM. The ASIC is an integrated circuit (IC) customized to perform, and the FPGA is an integrated circuit designed to be configured after manufacturing in order to perform, all or a part of the functions of the calculation device 50 illustrated in FIG. 1.

1. A spot welding monitoring method configured to monitor a state of spot welding that holds a work comprising metal plates stacked on each other, between electrodes in a pair, and supplies electricity between the electrodes, the spot welding monitoring method comprising:
by a converter disposed in a vicinity of a weld zone of the work, detecting a change in magnetic flux density of a magnetic field generated around the weld zone by the supplying of the electricity between the electrodes, and converting the change in the magnetic flux density into a current; and
calculating three-dimensional data on a melting zone of the work, based on a temporal change in a value of the current.

2. The spot welding monitoring method according to claim 1, wherein the detecting and converting of the change in the magnetic flux density comprises amplifying the magnetic flux density of the magnetic field generated around the weld zone, by a magnetic field generator disposed in a vicinity of the weld zone.

3. The spot welding monitoring method according to claim 1, further comprising determining whether quality of the weld zone is favorable or unfavorable, by comparing the calculated three-dimensional data and preset weld zone reference data.

4. The spot welding monitoring method according to claim 2, further comprising determining whether quality of the weld zone is favorable or unfavorable, by comparing the calculated three-dimensional data and preset weld zone reference data.

5. A spot welding monitoring system configured to monitor a state of spot welding that holds a work comprising metal plates stacked on each other, between electrodes in a pair, and supplies electricity between the electrodes, the spot welding monitoring system comprising:
a converter configured to be disposed in a vicinity of a weld zone of the work, and to detect a change in magnetic flux density of a magnetic field generated around the weld zone by the supplying of the electricity between the electrodes, and convert the change in the magnetic flux density into a current; and
a calculation device configured to calculate three-dimensional data on a melting zone of the work, based on a temporal change in a value of the current acquired by the converter.

6. The spot welding monitoring system according to claim 5, further comprising a magnetic field generator configured to be disposed in a vicinity of the weld zone, and to amplify magnetic flux generated around the weld zone.
